(19) United States
(12) Patent Application Publication
(10) Pub. No.: US 2020/0214484 A1
(43) Pub. Date: Jul. 9, 2020

(54) SUGAR-FREE EDIBLE VESSEL

(71) Applicant: LOLIWARE INC., Beacon, NY (US)

(72) Inventors: Chelsea Fawn BRIGANTI, Beacon, NY (US); Leigh Ann TUCKER, Beacon, NY (US)

(21) Appl. No.: 16/650,096

(22) PCT Filed: Aug. 31, 2018
(86) PCT No.: PCT/US2018/049212

§ 371 Date: Mar. 24, 2020

Related U.S. Application Data
(60) Provisional application No. 62/552,883, filed on Aug. 31, 2017.

(51) Int. Cl. A47G 21/18; A47G 19/22; A21D 13/48; A21D 2/18; A21D 13/062; A23G 3/54

(52) U.S. Cl. CPC A47G 21/18; A47G 19/2205; A21D 13/48; A47G 2400/105; A21D 13/062; A23G 3/545; A21D 2/18

(57) ABSTRACT

The present disclosure relates to low-sugar, and preferably sugar-free, edible and/or biodegradable materials, and to edible and/or biodegradable vessels for holding foods and liquids for consumption. Specifically, the disclosure relates to sugar-free edible and/or biodegradable cups, straws, and other vessels, capable of holding hot and/or cold liquids for extended periods of time. The present disclosure and its embodiments further relates to a sugar free edible and/or biodegradable vessel made from natural ingredients. The vessel may have an extended shelf life, and is sturdy enough to be used for a variety of applications.

### FIELD OF THE INVENTION

The present invention relates to edible and/or biodegradable materials, and to edible and/or biodegradable vessels for holding foods and liquids for consumption. Specifically, the invention relates to edible cups, straws, and other vessels, capable of holding hot and/or cold liquids for extended periods of time. The present invention and its embodiments further relates to a vessel made from natural ingredients. The vessel may have an extended shelf life, and is sturdy enough to be used for a variety of applications.

### BACKGROUND

Disposable cups made from plastics or plastic lined paper are a commonly used alternative to reusable drinking cups for their low cost and convenience. Both styrofoam and paper cups can hold hot liquids for extended periods of time. Disposable drinking straws made from plastic materials are likewise common. However, disposable cups and straws are not good for the environment. Because they are not biodegradable, they litter the environment or fill landfills. In addition, the plastics used in disposable cups are derived from fossil fuels.

Edible cups are an alternative to disposable cups that are better for the environment. Edible cups do not produce the harmful waste of disposable cups because they are eaten or quickly biodegrade if discarded. The most common types of edible cups, such as ice cream cones, are made from baked dough. These cups are made by pouring batter into a mold and then baking, forming dough around a mandrel and then baking, or baking and quickly forming. However, these types of edible cups cannot hold liquids for extended periods of time because they are not waterproof.

One solution to this problem is to coat the dough cup with a waterproof layer. U.S. Pat. No. 6,068,866 to Petrini discloses an edible cup made of twice-baked pastry with a waterproof layer made of sugar, water, starch, and gum that is capable of containing hot and cold drinks without leaking or losing its structural integrity. However, the cups are still limited to the structural integrity of baked dough. Because of the brittle nature of baked dough and its tendency to become stale, the resulting edible cup is not very durable as it tends to break or get soggy, is limited to certain usage scenarios, and has a limited shelf life.

Another type of edible cup is made from dehydrated fruits or vegetables. U.S. Pat. No. 6,423,357 to Woods discloses an edible container made of dehydrated fruit or vegetable formed into strips and wrapped around a mandrel. However, dehydrated fruit and vegetable is susceptible to rehydration when in contact with a liquid. Additionally, cups such as these suffer from both the strength limitations of the dehydrated fruit or vegetable and the difficulty in forming the dehydrated material into a cup shape.

Polylactic acid or polylactide (PLA) may be used to make a wide variety of vessels. Although PLA is marketed as a natural, bio-based, and biodegradable alternative to petroleum-based plastics, PLA is not biodegradable under natural conditions. Moreover, PLA is only compostable under specific industrial conditions, and accordingly is not an environmentally friendly alternative to other plastics.

Accordingly, there is a need for an improvement over existing disposable vessels that is biodegradable, easily formed into appropriate shapes and can hold hot and cold liquids for extended periods of time without losing its structural integrity.

Sugar-free foods and beverages are highly desired by consumers to meet certain dietary restrictions or for the distinct advantage of not contributing to tooth decay. However, sugar-free confections tend to be lower in viscosity or rigidity than corresponding sugar matrices, making sugar-free confections more difficult to process.

Accordingly, there is a need for an improvement over existing disposable vessels that are edible, biodegradable and/or compostable. Particularly for low-sugar or sugar-free consumables, there is a need for low-sugar or sugar-free vessels that are edible and biodegradable, and for processes for the preparation of such vessels.

### SUMMARY OF THE INVENTION

In order to be an effective substitute for disposable cups, straws or other vessels, the vessels of the invention are preferably able to withstand the hot and cold temperatures of food and beverages. In particular, given the large consumer demand of coffee and other beverages, cups and straws made from an alternative edible material should be able to hold both hot and cold liquids. While several examples of edible containers exist today, most lack the structural integrity and versatility required to hold liquids having different temperatures. The present invention addresses these and other shortcomings, and provides a sugar-free or low sugar edible and biodegradable vessel that is sufficiently ridged to be used as a cup or a straw, while also being able to withstand hot and/or cold beverages for an extended period of time.

The invention provides edible and/or biodegradable vessels that comprise a hydrocolloid such as alginate or agar, water, and optional additional ingredients including one or more of non-sugar sweeteners, flavoring agents, coloring agents, active ingredients, edible oils, plasticisers and natural preservatives. The vessel may also be coated with an edible coating, for example, to enhance waterproofing, improve shelf life, and/or reduce the stickiness of the vessel, or to provide flavor, color or graphics to the vessel. The vessels may hold liquids for an extended period of time, preferable more than about one hour. The vessel may be in the form of a cup or a drinking straw. The vessel is biodegradable, and moreover is compostable.

The invention also provides a process for the production of the edible and/or biodegradable vessels. The process comprises introducing a mixture comprising the hydrocolloid, water and optional ingredients into a mold comprising at least an inner form and one or more outer forms, allowing the hydrocolloid to set, removing an outer mold form, dehydrating the hydrocolloid while on the inner mold form, and removing the vessel from the inner mold form.

In other embodiments, the process for the production of the vessel comprises extruding a mixture comprising the hydrocolloid, water and optional ingredients. The process may further comprise cross-linking the hydrocolloid by the application of a crosslinking agent to the vessel.

### DETAILED DESCRIPTION OF THE INVENTION

As used herein, the term “sugar free” means that the composition or vessel is substantially free of dietary sugars, such as glucose, sucrose and fructose. As used herein, the term “low-sugar” refers to edible compositions, particularly in their post-processing form, that have less than 10% by weight of a dietary sugar, and preferably less than about 5% by weight.

As used here, the percent of ingredients in the vessel is the weight percent, unless otherwise specified.

The term “edible” as used herein refers to an item that may be consumed safely by the consumer, but may or may not be palatable or readily consumed.

The term “biodegradable” as used herein refers to an item that is capable of being broken down into innocuous products by the action of living things (such as microorganisms) under typical environmental conditions.

The term “compostable” as used herein refers to an item that is capable of being broken down under natural composing conditions into innocuous natural products. Accordingly, a material is referred to as compostable when it can biodegrade in a composting process, and preferably through the action of naturally occurring micro-organisms under naturally occurring composting conditions, and do so to a high extent within a specified timeframe. Preferable, a material that is compostable is degraded under natural (home) composting conditions to an extent of at least about 60%, or at least about 80% or at least about 90%, in less than a year, and preferably in less than about 6 months.

In preferred embodiments, materials are determined to be “biodegradable” and “compostable” according to the definitions as provided in EN-13432. According to EN-13432, biodegradability is the capacity of a material to be converted into CO2 by the action of micro-organisms. This property may be measured with the laboratory standard test method EN-14046 (also published as ISO 14855: biodegradability under controlled composting conditions). In order to show complete biodegradability, a biodegradation level of at least 90% is reached in 6 months or less.

Preferably, the materials described herein also show high disintegrability, i.e., the fragmentation and loss of visibility in the final compost (absence of visible pollution). Disintegration may be measured using a pilot scale composting test (EN 14045), in which specimens of the test material are composted with biowaste for 3 months and the final compost is screened with a 2 mm sieve. The mass of test material residues with dimensions greater than 2 mm should be less than 10% of the original mass of the test material.

The vessels described herein comprise a hydrocolloid. The vessel may further comprise additional ingredients including one or more of non-sugar sweeteners, flavoring agents, coloring agents, active ingredients, plasticizers, edible oils, and natural preservatives. The vessel may also be coated with an edible coating to enhance waterproofing, improve shelf life, and/or reduce the stickiness of the vessel, or to provide flavor, color or graphics to the vessel. The vessels may hold liquids for an extended period of time, preferable more than about one hour.

The invention also provides a process for the production of the vessels. In one embodiment, the process comprises introducing a mixture comprising the hydrocolloid, water and optional ingredients into a mold comprising at least an inner form and one or more outer forms, allowing the hydrocolloid to set, removing an outer mold form, dehydrating the hydrocolloid while on the inner mold form, and removing the vessel from the inner mold form. In another embodiment, a mixture comprising the hydrocolloid, water and optional ingredients is extruded to provide the vessel, followed by optional cross-linking.

### Hydrocolloid

The edible material of the present invention comprises one or more hydrocolloids. The hydrocolloids are polysaccharides that can gel when combined with water. Many hydrocolloids can change their physical behavior and characteristics with the addition or elimination of heat and have the ability to thicken and form gels at low concentrations. Hydrocolloids include agar, pectin, carrageenan, kappa/iota carrageenan, gelatin, corn starch, gellan gum, guar gum, gum arabic, isomalt, konjac, lecithin, locust bean gum, maltodextrin, methylcellulose, sodium alginate, xanthan gum, and tapioca. The hydrocolloid may be a mixture of the listed hydrocolloids. Preferred hydrocolloids have a biological source, such as a bacterial or a plant source, and particularly preferred hydrocolloids have a seaweed source. Preferred hydrocolloids include agar, carrageenans and alginates, or combinations thereof. Agars and alginates are particularly preferred.

Agar, also referred to as agar-agar, is a hydrocolloid and a natural vegetable counterpart to animal-derived gelatin. Agar is a flavorless gelling agent derived from a polysaccharide in red algae, where it accumulates in the cell walls. In chemical terms, agar is a polymer made up of subunits of the sugar galactose. The primary source for this substance is gracilaria lichenoides.

Alginates are natural polymers typically derived from seaweed and comprising linear copolymers of d-mannuronic acid and 1-guluronic acid units. Structurally, alginates are linear unbranched polymers containing covalently linked blocks of β(1-4)-linked d-mannuronic acid (M block) and α(1-4)-linked 1-guluronic acid (G block) residues, and may also comprise fractions of alternating guluronic and mannuronic acids (M/G block). Alginates are heterogeneous polymers with different contents of G and M blocks.

Alginates exist widely in brown seaweeds such as species of ascophyllum, durvillaea, ecklonia, laminaria, lessonia, macrocystis, sargassum, and turbinaria. Sodium alginate is the preferred alginate form since it is widely commercially available and is the first by-product of processing the alginate from the seaweed source.

Alginate polymers may form ionic cross-links in the presence of various divalent cations, e.g. Ca²⁺, Mg²⁺, etc., by cross-linking the carboxylate groups on the polymer.

Factors that are responsible for the stiffness or flexibility of the alginate gel include the relative MIG ratio of the alginate and the stoichiometry of alginate with the crosslinking M²⁺ cation. Higher G block content produces strong brittle gels, while higher M block content provides a more flexible gel. In some embodiments, and particularly for drinking straws, the alginate may comprise a high G-block alginate, optionally with the addition of some high MIG block alginate. A high G-block alginate may have a G:M ratio that is greater than 1:2, or greater than about 1:1, or greater than about 2:1, or greater than about 3:1. A preferred high G-block alginate has a G:M ratio of about between about 1:2 to 4:1. The alginate may a ratio of G:MIG:M of about 2:1:1 to about 4:1:1, for example about 2:1:1, or about 3:1;1 or about 4:1:1. The alginates used in the vessel may be a blend of different heterogeneous alginates.

Species of seaweed that may be used as a source of the alginate and their relative amounts of M-block, MIG block and G-block is provided below:

| Type of Seaweed | % MM | % MG & GM | % GG |
|---|---|---|---|
| Laminaia hyperborean (stem) | 17 | 26 | 57 |
| Laminaia hyperborean (leaf) | 36 | 38 | 26 |
| Lessonia nigrescens | 40 | 38 | 22 |
| Lessonia trabeculata | 25 | 26 | 49 |
| Durvillaea antarctica | 56 | 26 | 18 |

The vessel may comprise from about 15% to about 98% by weight of the hydrocolloid, particularly in the final, post dehydrated vessel. In other embodiments, the vessel may comprise from about 20% to about 90% by weight of the hydrocolloid; or from about 25% to about 80% by weight of the hydrocolloid, or from about 30% to about 65% by weight of the hydrocolloid, or from about 45% to about 60% by weight of the hydrocolloid, or from about 40% to about 50% of the hydrocolloid, or from about 50% to about 60% of the hydrocolloid.

### Water-Based Liquid

The water in the edible material may be supplied as pure water or as a water based liquid. According to some embodiments, water such as filtered water, distilled water, purified water, spring water, and mineral water may be used. Additional water-based liquids that may be alternatively or additionally used are juice, juice concentrate, milk, treacle, tree and cactus waters, alcoholic beverage, energy drinks, caffeinated coffee, decaffeinated coffee, soda, nut milks, coconut milk, flavored milks, flavored waters, teas, tea infusions, hot chocolate, ciders, cold-pressed juices, sports drinks, coconut water, fermented liquids, such as kombucha and kvass and herbal infusions.

In some embodiments, and particularly for agar-based vessels, the vessel may comprise from about 35% to about 70% by weight of water. In other embodiments, the vessel may comprise from about 35% to about 65% by weight of water, or from about 45% to about 65% by weight of water, or from about 40% to about 55% by weight of water, or from about 40% to about 50% by weight of water.

In other embodiments, water is substantially removed from the vessel during dehydration, providing a vessel having less than 10% by weight of water, or less than about 5% by weight of water, or less than about 1% by weight of water. Particularly, alginate-containing vessels may have a low final water content.

Embodiments of the vessels described herein can further include one or more additional ingredients such as, for example, flavors, colors, spices, acids, actives or a combination thereof described in more detail below.

### Non-Sugar Sweetener

The vessel may contain a low calorie, or preferably, a zero-calorie sweetener. It is preferred that the sweetener is a natural agent that is derived from a biological source, and particularly a plant source. The sweetener may include one or more of stevia, erythritol, monk fruit, etc. The sweetener may also include a sugar substitute such as maltitol, lactitol, mannitol, xylitol, or sorbitol.

### Edible Oils

The vessel may optionally contain one or more edible oils. The edible oils are preferably derived from a plants plant source. Edible oils may include one or of vegetable glycerin, palm oil, and the like. The edible oil may be an essential oil. The edible oil may be present in the vessel in an amount up to about 10% by weight of the vessel. The edible oil may be present in the vessel in an amount of about 1% to about 10% by weight, or in an amount from about 2% to about 5% by weight.

### Plasticizer

The vessel may optionally contain one or more edible plasticizers. The plasticizer may modify the texture and/or viscosity of the hydrocolloid mixture to provide one or more desirable properties, including increased ease of processing, more desirable plastic-like properties (i.e., spring-back) and also to provide a material that can be bitten through. The plasticizer may comprise an edible oil, glycerin, a sugar alcohol such as maltitol, sorbitol or xylitol, microcrystalline cellulose, acacia gum, shellac, chitosan, genepin, nano emulsions, algae oil, coconut oils, processed shea butter, ester gums, carnuba wax, ethocell, zein, or mixtures thereof. A preferred plasticizer is glycerin.

The plasticizer may be present in the vessel in an amount of from about 0% to about 70% by weight, or from about 5% to about 60%.

In embodiments where the hydrocolloid provides a more ridged gel, for example for alginates, and particularly for high G-block alginates, the vessel may comprise from 5 to about 70% by weight of plasticizer; or from 15% to about 65% by weight of plasticizer; or from about 25% to about 65% by weight of plasticizer, or about 40% to about 60% by weight of plasticizer, or about 50% to about 60% by weight of plasticizer. Vessels may also be made for some applications that are free of plasticizer.

### Flavoring Agents

The vessel may also include one or more flavoring agents and/or fragrances. Flavoring agents and fragrances suitable for the invention are preferably derived from natural sources such as plants, herbs, spices, and the like. Various flavoring agents and/or fragrances may include, but are not limited to, grapefruit, cherry, matcha green tea, vanilla, chocolate, raspberry, strawberry, cranberry, passionfruit, apple, blueberry, papaya, lemon, lime, champagne, grape, banana, watermelon, honey, peach, orange, kiwi, pomegranate, plum, coconut, yuzu, and the like or any combination thereof. Flavoring agents may also include one or more edible florals such as rose water, damascenea rose, jasmine, lavender, and the like. Representative examples of flavoring agents are available from Abelei, The Tec Team, Virginia Dare, Silesia, Carmi Flavors, Fruit D'Or, American Fruit Flavors, Lakewood Organic, and Comax Flavors and are present in about 0.1% to about 10% by weight. In some embodiments, no flavoring agents are used.

### Coloring Agents

Coloring agents may be used to color the edible material. The coloring agent may be added as an optional ingredient in the pre-processing mixture, or may be applied to the vessel as an edible coating. Preferably, the coloring agent is derived from a plant source and is present in the composition in the amount of about 0.1% to about 10% by weight. Representative coloring agents are available from DDW Color House, Food Ingredient Solutions, GNT, Natural Flavors Inc., and Sensient Food Colors. Depending on the coloring agent or agents chosen, the edible cups may be translucent, opaque, or clear. Some embodiments may be devoid of any coloring agent. The coloring agent may be applied to provide a particular appearance, for example striated, color blocked, faded from one color to another, changing in color throughout, tie-dye or marble swirls.

### Active Ingredients

The vessel may include one or more active ingredients. Materials that may be included as an active ingredient include vitamins, minerals, phytonutrients (e.g., carotenoids, flavonoids, resveratrol, and glucosinolates), anti-oxidants, fiber, fatty acids such as omega-3 fatty acid, stimulants such as caffeine and PureEnergy® (caffeine pterostilbene co-crystal), amino acids, polypeptides, proteins (plant and insect-based, i.e., cricket, etc.), cannabis oil, CBD oil, plant-based charcoal for detoxification, brain supplements such as lion's mane and Cordyceps, nootropics such as hyperzine-A, acetal choline, DHA, GABA, phosphatidylserine, L-Thyanine, Turkey Tail, Chaga immunity mushrooms, collagen and collagen peptides, botanicals, and plant extracts. An active ingredient can include any plant-derived material that is safe for human consumption, including herbal extracts, botanical extracts, and the like, such as Gotu Kola, Kola Nut, Bacopa Manieri, ginseng, Gingko Biloba, Schisandra, Goji Berry, turmeric, ginger, terpenes, and aromatic isolates (alpha-pinene, myrcene and the like). Other materials, such as prebiotics, probiotics, can also be used as an active ingredient.

Vitamins may include Vitamins A, B-complex (such as B-1, B-2, B-6 and B-12), C, D, E and K, niacin and acid vitamins such as pantothenic acid and folic acid and biotin. Minerals may include calcium, iron, zinc, magnesium, iodine, copper, phosphorus, manganese, potassium, chromium, molybdenum, selenium, nickel, tin, silicon, vanadium and boron.

Specific actives may include, by way of example, caffeine, b-glucan, isoflavones, lignans, lycopene, allicin, glucosinolates, limonoids, polyphenols, catechins (e.g. epigallocatechin-3-gallate, epigallocatechin, epicatechin-3-gallate, epicatechin), phenolics, omega fatty acids including EPA and DHA, conjugated linoleic acid, capsicum, ginseng, Echinacea purpurea, kola nut, passion flower, St. Johns Wort, Ma Huang/guarana, kava kava and chamomile.

### Natural Preservatives

The vessel may comprise one or more natural preservatives. The preservative may be an anti-oxidant such as a tocopherol. The preservative may comprise citric acid. Alternatives such as lemon juice, lemon powder, ascorbic acid, tartaric acid, malic acid, and sour salt may also be used.

### Coating

The vessel may be coated with an edible coating to enhance the waterproofing and to extend shelf life. For some vessels, the coating may reduce the stickiness of the vessel. In one embodiment, the edible coating comprises vegetable oils, including but not limited to coconut oil, palm oil, beechnut oil, castor oil, cottonseed oil, groundnut oil, hazelnut oil, olive oil, palm kernel oil, peanut oil, peel oil, poppy oil, black current seed oil, flaxseed oil, amaranth oil, apricot oil, raisin seed oil, rapeseed oil, rice bran oil, safflower oil, sesame oil, sunflower seed oil, tucum oil, soybean oil, almond oil, brazil nut oil, cashew oil, macadamia oil, mongongo nut oil, pine nut oil, pistachio oil, and walnut oil; short or medium or long chain triglycerides, monoglycerides, and/or diglycerides; confectioner's glaze; acetylated monoglycerides; edible waxes such as beeswax; and shellac. In preferred embodiments, the edible coating comprises an edible wax such as beeswax, ricebran wax or carnuba wax. In one embodiment, the edible coating may be applied to the vessel after the vessel has been molded and dried. In other embodiments, the edible coating may be applied to the vessel during the drying process. The coating may be applied by spraying, dipping, brushing, edible ink-jet printing or otherwise applied to the inner and/or outer surfaces of the vessel.

### Cross-Linking

The hydrocolloid in the vessel may cross-linked by the addition a crosslinking agent. The crosslinking may provide a final product with improved properties such as stiffness, tensile strength, and water resistance. Preferred cross-linking agents are either non-toxic and/or may be substantially removed from the vessel, and accordingly do not affect the use of the vessel to contain a drinkable liquid or food product.

The cross linking agent may be a metal cation, particularly when the hydrocolloid is alginate, carrageenan or pectin. The cross-linking agent may be added to the mixture containing the hydrocolloid prior to processing (i.e., by molding, casting, extruding) to its final shape, so long as the reaction with the cross-linker does not interfere with subsequent processing. The cross-linking agent may be applied to the vessel after it has been processed into its final shape. When the crosslinking agent is applied to the vessel, a solution of the cross-linker may be applied by brushing, dipping, spraying, etc. a solution of the crosslinking agent onto one or more of the surfaces of the vessel. In some embodiments, the vessel is immersed in a solution of the crosslinking agent.

Particularly for when the hydrocolloid comprises an alginate, the vessel may be cross-linked by exposure of the alginate to a metal cation having a 2+ charge. Preferred metal cations for cross-linking the alginate include Ca²⁺ and Mg²⁺. The counterion may be any acceptable non-toxic anion, such as halides (chloride, bromide, fluoride, and preferably chloride). The metal cation may be applied to the vessel as an aqueous solution of the metal salt. The metal salt solution may be applied to the vessel by spraying, brushing, dipping, etc. Preferably, the metal salt solution is left in contact with vessel for a sufficient period of time for the metal cation to diffuse into the vessel and provide cross linking of the alginate. The concentration of the metal salt in the aqueous solution may range from 2% by weight to saturated, and more preferably from about 5% to about 15% by weight.

### Process

The vessel of the invention may be prepared, for example, by molding, casting, or extruding a composition comprising the hydrocolloid, water, and optional ingredients.

The vessel of the invention may be prepared according to the steps provided below:

For heat activated hydrocolloids, a pre-process mixture is prepared by:
(a) the hydrocolloid is added to water and/or water-based liquid to provide a mixture pre-process mixture;
(b) the mixture comprising the hydrocolloid is heated to activate the hydrocolloid;
(c) optionally the heated mixture is concentrated by the evaporation of water;
(d) the mixture may be cooled to a pre-casting temperature;
(e) optionally, additional ingredients are added either to the water or water-based liquid prior to the addition of the hydrocolloid, and/or prior to the heat activation of the hydrocolloid, and/or are added after the mixture is cooled to a pre-casting temperature to provide a final pre-process mixture.

In other embodiments, the pre-process mixture is prepared by:
(a) the hydrocolloid is added to water and/or water-based liquid to provide a mixture pre-process mixture;
(b) optional ingredients, including plasticizers, coloring, flavoring, etc. may be added either before or after the addition of the hydrocolloid;
(c) the mixture may be cooled to a pre-processing temperature;

The vessel may be prepared from the pre-process mixture comprising the hydrocolloid and other ingredients by:
(i) forming the shape of the vessel by introducing the pre-process mixture of the hydrocolloid into a mold that comprises an inner form and an outer form;
(ii) allowing the hydrocolloid to set;
(iii) removing an outer form;
(iv) dehydrating the vessel while maintaining the vessel on the inner form;
(v) removing the inner form;
(vi) optionally, coating the vessel;
(vii) optionally, applying a solution comprising a cross-linking agent to one or more surfaces of the vessel after one or more of the steps (iii), (iv) or (v).

Alternatively, the vessel is prepared from the pre-process mixture comprising the hydrocolloid and other ingredients by:
(i) extruding the pre-process mixture;
(ii) applying a solution comprising a cross-linking agent to one or more surfaces of the vessel;
(iii) dehydrating the vessel.

The extrusion may be tube extrusion, for example to form a straw. The extrusion may be onto a mandrel. When the extrusion is onto a mandrel, the composition may be dehydrated while still on the mandrel, prior to the vessel being released from the mandrel.

In some embodiments, and particularly for heat-activated hydrocolloids such as agar, the hydrocolloid is added to water and/or water-based liquid to provide a pre-process mixture comprising about 1 to about 6 percent of the hydrocolloid, and preferably comprising 1 to 5 percent of the hydrocolloid. The mixture is stirred with heating. The heating is typically performed until the mixture reaches a temperature of about 80° C. to about 100° C. The mixture may be heated until a boil is achieved. The temperature may be maintained for a sufficient time to activate the hydrocolloid. The mixture may be maintained at the elevated temperature for a time of from about 1 minute to about an hour.

During the process of making the edible material, water may be lost to evaporation (e.g., by cooking/boiling and/or by natural or forced drying). For example, during the heating and activation of the hydrocolloid, water may be evaporated from the mixture concentrating the hydrocolloid. Therefore, the water content by weight in the post-cooking hydrocolloid mixture may be less than the initial hydrocolloid mixture by weight. In some embodiments, up to about 35% of the initial water is lost. In some embodiments, from about 5%-30% of the initial water amount is lost, or about 15 to about 25% of the initial water is lost.

According to certain embodiments, and particularly when the hydrocolloid is agar, chitosan, gellan-guar-xanthan gum, konjac, and most particularly, the vessel is made from a pre-process mixture comprising about 1.5% to about 5% by weight hydrocolloid and about 80% to about 98.5% by weight of water, or from about 85% to about 98% by weight of water, or from about 95% to about 98% by weight of water.

When the hydrocolloid is alginate, the vessel may be made from a pre-process mixture that comprises from about 0.5% to about 40 alginate, or from about 1 to about 30% alginate, or from about 3% to about 20% alginate, or from about 5% to about 15% alginate, or from about 7% to about 13% alginate.

The pre-process mixture may further comprise a plasticizer, such as glycerin, in an amount of about 0.5% to about 40%, or from about 1 to about 30%, or from 3% to about 25%, or from about 5% to about 20%, or from about 8% to about 20%. The ratio of the alginate by weight to the plasticizer by weight may be from about 1:2 to about 2:1, or from about 1:1.5 to about 1.5:1, or from about 1:1 to 1:1.5. In some embodiments, the pre-process mixture may be free of plasticizer.

If the hydrocolloid solution is activated at high temperature, and particularly if the hydrocolloid solution is activated by boiling, the resulting hydrocolloid solution may be cooled to a pre-molding temperature prior to the molding of the vessel. In this embodiment, the temperature of the hydrocolloid mixture prior to molding of the vessel may be cooled to a temperature between about 60° C. to about 90° C., or from about 75° C. to about 85° C.

In other embodiments, and particularly for pre-process mixtures comprising alginate as a hydrocolloid, the pre-process mixture may be cooled prior to molding, casting or extruding. The pre-process mixture may be cooled to a temperature between about 0° C. to about 10° C. The pre-process mixture may be cooled for from 1 to 48 hrs.

The additional ingredients for the vessel may be added to the hydrocolloid mixture at any point during the process for preparing the final hydrocolloid solution. Additional ingredients are added either to the water or water-based liquid prior to the addition of the hydrocolloid, and/or prior to the heat activation of the hydrocolloid, and/or are added after the mixture is cooled to a pre-casting temperature to provide a final pre-process mixture. Particularly, in the case of ingredients that may be degraded under the exposure to high temperatures (such as boiling water during the hydrocolloid activation), it is preferred that such ingredients are added to the hydrocolloid mixture after the heat activation, but prior to casting or molding of the vessel.

Once the final hydrocolloid mixture is prepared, it may be extruded, molded, or cast into a variety of shapes for the vessel. The vessel may be molded, for example, using a polycarbonate or food-grade silicone mold. The molds may comprise at least one, and as many as three or more, separate parts. The mold will comprise at least one inner form, which defines the shape of the interior portion of the vessel. The mold will also typically comprise one or more outer forms, which define the shape of the outer surface of the vessel. In other embodiments, other materials and molding processes may be utilized in making the vessels.

The vessel is allowed to set (cure) in the mold. Once the vessel is set, outer form(s) of the mold is removed. The vessel is preferably not removed from the inner form until after the subsequent dehydration of the vessel, to avoid deformation of the vessel shape. The mold may be pre-treated with a releasing agent to facilitate the removal of the mold forms from the vessel. Releasing agents may be selected from vegetable oils.

The vessel may be subject to dehydration while still on the inner form in order to maintain the size and shape of the vessel during dehydration. Dehydration helps to reinforce the structural integrity of the vessel by removing excess water to make the material more durable. Dehydration is typically applied to an vessel once the edible material has been molded and an outer mold form is removed. In an embodiment of a vessel, once the outer mold form(s) have been removed from the vessel, the vessels on the inner mold form are placed onto metal trays and moved into a dehydrator to remove excess moisture.

The dehydrator may be a commercial dehydrator, convection oven, vacuum dehydrator, or the like. The temperature of dehydration may be from about 35 to about 70° C., or from about 40 to about 60° C. The vessels may be left in the dehydrator for a period of about one hour to about twenty four hours until the vessel has the appropriate texture and moisture content.

In one embodiment, the vessel may have a net water loss approaching 100% of the water from the pre-processing mixture. In some embodiments, water loss is up to 96% by weight of the vessel from dehydration. In another embodiment, the vessel may have a net water loss of from about 80% to about 95% by weight of the vessel from dehydration, or from about 85% to about 95% by weight of the vessel. Particularly, for the alginate-based vessel, the water loss may be between 90% to about 99.99% by weight from dehydration.

The final dehydrated vessel may have a moisture content of about 35% to about 70%. In other embodiments, the moisture content of the final vessel is from about 35% to about 65%, or from about 45% to about 65%; or from about 40% to about 55% by weight. In other embodiments, the moisture content is about 40% to about 50%. In other embodiments, and particularly for the alginate-based vessels, the final water content may be between about 0% to 4% by weight.

The removal of water during dehydration may be monitored to ensure that the desired final moisture content is achieved. In some embodiments, the weight of the vessel may be monitored to determine moisture content of the vessel during and/or after the dehydration.

The wall thickness of the vessel after dehydration may be from about 0.1 mm to about 3 mm. For vessels such as cups, the wall thickness may be from about 0.5 to about 3 mm or from about 0.7 mm to about 2 mm. For drinking straws the wall thickness may be from about 0.1 mm to about 0.8 mm.

Once a vessel has been dehydrated, it may be coated to make enhance the waterproofing and to provide a smooth finish to the final product. The vessels may be coated with a wax-based, edible coating. The containers may be coated with an edible coating that is used to give the vessels a glossy, sheen finish and to reduce stickiness. The coating may also enhance the shelf life of the vessels to twelve months without refrigeration. The coating may be applied by any conventional method, including spraying, painting, rolling, dipping, etc.

The coating may be applied to the vessel through a spraying process. The vessels may be placed on a spinning surface and the coating spray is applied to the outside surface of the containers as they are being spun. The inside surface may also be coated through spraying. The coated vessels are dried, for example, with fans for up to twenty-four hours. The coating may add about 0.1 grams to about 2 grams to the overall weight of the edible object and more preferably about 0.2 grams to about 1.2 grams. The edible coating may also facilitate use of the vessel to hold hot liquids such as coffee, tea, soups, hot chocolate, and other beverages ranging in temperature from 32 to 180 degrees Fahrenheit. According to certain embodiments, the edible coating may enable the vessel to hold liquids of about 160 degrees Fahrenheit over and hour, and preferably for 3 or more hours. The coating may be present in thicknesses of about 0.5 mm to about 3 mm and more preferably about 1 mm.

The edible material may also be molded into different shapes. In one embodiment, the vessel is in the form of a cup that is suitable for holding beverages. In some embodiments, the edible cup may contain low viscosity liquids such as water, fruit juice, milk, alcoholic beverages, coffees, teas, sports drinks, sodas, and other drinks for extended periods of time without degrading, preferably over an hour or more.

In another embodiment, the vessel is a drinking straw. The drinking straw also may be suitable for use in consuming either cold or hot beverages over an extended periods of time without substantially reducing functionallity, preferably over an hour or more. The drinking straw may have any configuration, such as a cylindrical drinking straw, a spoon straw, a cocktail straw, a bubble tea straw, or the like. The straw may have an inner diameter from about 2 mm to about 15 mm, or from about 3 mm to about 10 mm.

In addition to cups and straws, the vessel may be in the form of other containers, lids, utensils, and other table top containers using the same ingredients. Other embodiments of vessels are within the scope of the present invention. Such embodiments may be drinkware such as teacups, mugs, stemware, shot glasses, cocktail glasses, lowballs, abd highballs: flatware such as spoons, knives, forks, and utensils; tableware such as plates, saucers, and bowls; serving ware such as platters, serving bowls, pitchers, and jugs.

Another embodiment of the vessel is an edible shell or cup used to contain a food filling. The edible films, skins and shells may be used to form candy, pastas such as ravioli, dumplings, wontons, mochi, and tortilla skins used to wrap or encase food fillings such as syrups, jellies, ganaches, chocolate, meat, vegetable, cheese, fruit, nut, ice cream, paste, peanut butter, syrup, sugar, and candy. The edible food shells or cups used to hold or encase food fillings may also be frozen to hold frozen ingredients such as ice cream. In another embodiment, the edible material may comprise of an iced casing used to hold flavorings for infusing drinks.

In other embodiments, the materials disclosed herein may be used as an edible and/or biodegradable film or coating.

The edible material may also be used to form edible clothing in the intimacy industry such as edible lingerie, edible underwear, edible accessories and toys. The concentration of the ingredients used for making the edible material may be adjusted by weight to produce a softer, more pliable material or a harder, more rigid material.

### Aspects of the Invention

The invention provides the below, non-limiting aspects:

Aspect 1: A low-sugar or sugar-free edible and/or biodegradable vessel, comprising a hydrocolloid.

Aspect 2: The low-sugar or sugar-free edible and/or biodegradable vessel according to aspect 1, comprising 15% to about 98% by weight of the hydrocolloid in the final, post dehydrated vessel; or from about 20% to about 90% by weight of the hydrocolloid; or from about 25% to about 80% by weight of the hydrocolloid, or from about 30% to about 65% by weight of the hydrocolloid, or from about 45% to about 60% by weight of the hydrocolloid, or from about 40% to about 50% of the hydrocolloid, or from about 50% to about 60% of the hydrocolloid.

Aspect 3. The low-sugar or sugar-free edible and/or biodegradable vessel according to aspect 1, comprising from about 40% to about 50% by weight of the hydrocolloid.

Aspect 4: The low-sugar or sugar-free edible and/or biodegradable vessel according to any one of aspects 1 to 3, wherein the hydrocolloid is selected from one or more of agar, pectin, carrageenan, kappa/iota carrageenan, gelatin, corn starch, gellan gum, guar gum, gum arabic, isomalt, konjac, lecithin, locust bean gum, maltodextrin, methylcellulose, sodium alginate, xanthan gum, and tapioca.

Aspect 5: The low-sugar or sugar-free edible and/or biodegradable vessel according to any one of aspects 1 to 4, wherein the hydrocolloid is derived from a biological source, or from a plant source.

Aspect 6: The low-sugar or sugar-free edible and/or biodegradable vessel according to any one of aspects 1 to 4, wherein the hydrocolloid is derived from a seaweed source.

Aspect 7: The low-sugar or sugar-free edible and/or biodegradable vessel according to any one of aspects 1 to 4, wherein the hydrocolloid is selected from the group consisting of agar, carrageenans and alginate, or combinations thereof.

Aspect 8: The low-sugar or sugar-free edible and/or biodegradable vessel according to any one of aspects 1 to 4, wherein the hydrocolloid is agar.

Aspect 9: The low-sugar or sugar-free edible and/or biodegradable vessel according to any one of aspects 1 to 4, wherein the hydrocolloid is an alginate.

Aspect 10: The low-sugar or sugar-free edible and/or biodegradable vessel according to aspect 9, wherein the alginate comprises a high G-block alginate.

Aspect 11: The low-sugar or sugar-free edible and/or biodegradable vessel according to aspect 10, wherein the alginate comprises an alginate having a G:M ratio G:M ratio of about between about 1:2 to 4:1; or having a G:M ratio that is greater than 1:2, or greater than about 1:1, or greater than about 2:1, or greater than about 3:1.

Aspect 12: The low-sugar or sugar-free edible and/or biodegradable vessel according to any one of aspects 9 to 11, wherein the alginate is crosslinked with a 2+ metal cation.

Aspect 13: The low-sugar or sugar-free edible and/or biodegradable vessel according to aspect 12, wherein the 2+ metal cation is Ca²⁺.

Aspect 14: The low-sugar or sugar-free edible and/or biodegradable vessel according to any one of aspects 1 to 13, further comprising a plasticizer.

Aspect 15: The low-sugar or sugar-free edible and/or biodegradable vessel according to aspect 14, wherein the plasticizer comprises one or more of an edible oil, glycerin, a sugar alcohol such as maltitol, sorbitol or xylitol, microcrystalline cellulose, acacia gum, shellac, chitosan, genepin, nano emulsions, algae oil, coconut oils, processed shea butter, ester gums, carnuba wax, ethocell, and zein.

Aspect 16: The low-sugar or sugar-free edible and/or biodegradable vessel according to aspect 14, wherein the plasticizer comprises glycerin.

Aspect 17: The low-sugar or sugar-free edible and/or biodegradable vessel according to any one of aspects 14 to 16, wherein the plasticizer is present in the vessel in an amount from about 0% to about 70% by weight, or from about 5% to about 60%.

Aspect 18: The low-sugar or sugar-free edible and/or biodegradable vessel according to any one of aspects 14 to 16, wherein the plasticizer is present in the vessel in an amount from 5 to about 70% by weight of plasticizer; or from 15% to about 65% by weight of plasticizer; or from about 25% to about 65% by weight of plasticizer, or about 40% to about 60% by weight of plasticizer, or about 50% to about 60% by weight of plasticizer.

Aspect 19: The low-sugar or sugar-free edible and/or biodegradable vessel according to any one of aspects 1 to 8, further comprising a low calorie, or preferably, a zero-calorie sweetener.

Aspect 20: The low-sugar or sugar-free edible and/or biodegradable vessel according to aspect 19, wherein the sweetener is selected from one or more of stevia, erythritol, and monk fruit.

Aspect 21: The low-sugar or sugar-free edible and/or biodegradable vessel according to any one of aspects 1 to 20, further comprising one or more edible oils.

Aspect 22: The low-sugar or sugar-free edible and/or biodegradable vessel according to aspect 21, wherein the edible oils are derived from a plants plant source.

Aspect 23: The low-sugar or sugar-free edible and/or biodegradable vessel according to aspect 21, wherein the edible oil comprises vegetable glycerine or palm oil.

Aspect 24: The low-sugar or sugar-free edible and/or biodegradable vessel according to any one of aspects 21 to 23, wherein the vessel comprises the edible oil in an amount up to about 10% by weight of the vessel.

Aspect 25: The low-sugar or sugar-free edible and/or biodegradable vessel according to any one of aspects 21 to 23, wherein the vessel comprises the edible oil in an amount of about 1% to about 10% by weight.

Aspect 26: The low-sugar or sugar-free edible and/or biodegradable vessel according to any one of aspects 21 to 23, wherein the vessel comprises the edible oil in an amount of about 2% to about 5% by weight.

Aspect 27: The low-sugar or sugar-free edible and/or biodegradable vessel according to any one of aspects 1 to 26, further comprising one or more flavoring agents

Aspect 28: The low-sugar or sugar-free edible and/or biodegradable vessel according to aspect 27, wherein the flavoring agent is derived from a natural sources such as plants, herbs, spices, and the like.

Aspect 29: The low-sugar or sugar-free edible and/or biodegradable vessel according to aspect 27, wherein the flavoring agent is selected from one or more of grapefruit, cherry, matcha green tea, vanilla, chocolate, raspberry, strawberry, cranberry, passionfruit, apple, blueberry, papaya, lemon, lime, champagne, grape, banana, watermelon, honey, peach, orange, kiwi, pomegranate, plum, coconut, and yuzu.

Aspect 30: The low-sugar or sugar-free edible and/or biodegradable vessel according to any one of aspects 1 to 29, further comprising one or more coloring agents.

Aspect 31: The low-sugar or sugar-free edible and/or biodegradable vessel according to aspect 30, wherein the coloring agent is derived from a plant source.

Aspect 32: The low-sugar or sugar-free edible and/or biodegradable vessel according to any one of aspects 1 to 31, further comprising or more active ingredients.

Aspect 33: The low-sugar or sugar-free edible and/or biodegradable vessel according to aspect 32, wherein the active ingredient is selected from one or more of vitamins, minerals, phytonutrients (e.g., carotenoids, flavonoids, resveratrol, and glucosinolates), anti-oxidants, fiber, fatty acids such as omega-3 fatty acid, stimulants such as caffeine, amino acids, polypeptides, botanicals, and plant extracts.

Aspect 34: The low-sugar or sugar-free edible and/or biodegradable vessel according to any one of aspects 1 to 33, further comprising one or more natural preservatives.

Aspect 35: The low-sugar or sugar-free edible and/or biodegradable vessel according to aspect 34, wherein the natural preservative is selected from one or more of tocopherol and citric acid.

Aspect 36: The low-sugar or sugar-free edible and/or biodegradable vessel according to any one of aspects 1 to 35, further comprising one or more edible coatings to enhance the waterproofing, extend shelf life, and/or reduce the stickiness of the vessel.

Aspect 37: The low-sugar or sugar-free edible and/or biodegradable vessel according to aspect 36, wherein the coating comprises vegetable oils, including but not limited to coconut oil, palm oil, beechnut oil, castor oil, cottonseed oil, groundnut oil, hazelnut oil, olive oil, palm kernel oil, peanut oil, peel oil, poppy oil, black current seed oil, flaxseed oil, amaranth oil, apricot oil, raisin seed oil, rapeseed oil, rice bran oil, safflower oil, sesame oil, sunflower seed oil, tucum oil, soybean oil, almond oil, brazil nut oil, cashew oil, macadamia oil, mongongo nut oil, pine nut oil, pistachio oil, and walnut oil; short or medium or long chain triglycerides, monoglycerides, and/or diglycerides; confectioner's glaze; acetylated monoglycerides; edible waxes such as beeswax; and shellac.

Aspect 38: The low-sugar or sugar-free edible and/or biodegradable vessel according to aspect 36, wherein the coating comprises an edible wax such as beeswax.

Aspect 39: The low-sugar or sugar-free edible and/or biodegradable vessel according to any one of aspects 1 to 38, wherein the vessel is capable of holding liquids for at least about one hour.

Aspect 40: The low-sugar or sugar-free edible and/or biodegradable vessel according to any one of aspects 1 to 38, wherein the vessel is capable of holding hot liquids and/or cold liquids for at least about one hour.

Aspect 41: The low-sugar or sugar-free edible and/or biodegradable vessel according to any one of aspects 1 to 40, wherein the vessel is a cup.

Aspect 42: The low-sugar or sugar-free edible and/or biodegradable vessel according to any one of aspects 1 to 40, wherein the vessel is a drinking straw.

Aspect 43: An edible and/or biodegradable drinking straw, comprising an alginate, and optionally plasticizer.

Aspect 44: The edible and/or biodegradable straw according to aspect 43, comprising 20% to about 90% by weight of the alginate; or from about 25% to about 80% by weight of the alginate, or from about 30% to about 65% by weight of the alginate, or from about 45% to about 60% by weight of the alginate, or from about 40% to about 50% of the alginate, or from about 50% to about 60% of the alginate.

Aspect 45: The edible and/or biodegradable straw according to aspects 43 or 44, wherein the alginate comprises a high G-block alginate.

Aspect 46: The edible and/or biodegradable straw according to aspect 45, wherein the alginate comprises an alginate having a G:M ratio G:M ratio of about between about 1:2 to 4:1; or having a G:M ratio that is greater than 1:2, or greater than about 1:1, or greater than about 2:1, or greater than about 3:1.

Aspect 47: The edible and/or biodegradable straw according to any one of aspects 43 to 46, wherein the alginate is cross-linked with a 2+ metal cation.

Aspect 48: The edible and/or biodegradable straw according to aspect 47, wherein the 2+ metal cation is Ca²⁺.

Aspect 49: The edible and/or biodegradable straw according to any one of aspects 43 to 48, further comprising a plasticizer.

Aspect 50: The edible and/or biodegradable straw according to aspect 49, wherein the plasticizer comprises one or more of an edible oil, glycerin, a sugar alcohol such as maltitol, sorbitol or xylitol, microcrystalline cellulose, acacia gum, shellac, chitosan, genepin, nano emulsions, algae oil, coconut oils, processed shea butter, ester gums, carnuba wax, ethocell, and zein.

Aspect 51: The edible and/or biodegradable straw according to aspect 49, wherein the plasticizer comprises glycerin.

Aspect 52: The edible and/or biodegradable straw according to any one of aspects 49 to 51, wherein the plasticizer is present in the straw in an amount of from about 0% to about 70% by weight, or from about 5% to about 60%.

Aspect 53: The edible and/or biodegradable straw according to any one of aspects 49 to 51, wherein the plasticizer is present in the straw in an amount of from about 5 to about 70% by weight of plasticizer; or from 15% to about 65% by weight of plasticizer; or from about 25% to about 65% by weight of plasticizer, or about 40% to about 60% by weight of plasticizer, or about 50% to about 60% by weight of plasticizer.

Aspect 54: The edible and/or biodegradable vessel or straw according to any one of aspects 1 to 53, wherein the vessel or straw is compostable.

Aspect 55: The edible and/or biodegradable vessel or straw according to any one of aspects 1 to 53, wherein the vessel or straw is degraded under natural (home) composting conditions to an extent of at least about 60%, or at least about 80% or at least about 90%, in less than a year, and preferably in less than about 6 months.

Aspect 56: The edible and/or biodegradable vessel or straw according to any one of aspects 1 to 53, wherein the vessel or straw is biodegradable according to the definitions and methods as provided by EN-13432.

Aspect 57: The edible and/or biodegradable vessel or straw according to any one of aspects 1 to 53, wherein the vessel or straw has a biodegradation level of at least 90% that is reached in 6 months or less as measured with the laboratory standard test method EN-14046 (also published as ISO 14855: biodegradability under controlled composting conditions).

Aspect 58: The edible and/or biodegradable vessel or straw according to any one of aspects 1 to 57, wherein the vessel or straw has a disintegration measured using pilot scale composting test (EN 14045), in which specimens of the test material are composted with biowaste for 3 months and the final compost is screened with a 2 mm sieve, wherein the mass of test material residues with dimensions greater than 2 mm is less than 10% of the original mass of the test material.

Aspect 59: A process for making the low-sugar or sugar-free edible and/or biodegradable vessel according to any one of the aspects 1 to 42, comprising the steps of:

introducing a hot solution comprising a hydrocolloid, water and optional ingredients into a mold comprising at least an inner form and one or more outer forms,
allowing the hydrocolloid to set,
removing an outer mold form,
dehydrating the hydrocolloid while on the inner mold form,
removing the vessel from the inner mold form.

Aspect 60: The process according to aspect 59, wherein the hot solution comprising the hydrocolloid, water and optional ingredients comprises about 1.5% to about 5% by weight of the hydrocolloid.

Aspect 61: The process according to aspect 59 or 60, wherein the hydrocolloid is agar.

Aspect 62: The process according to aspect 61, wherein the net water loss during dehydration is from about 80% to about 95% by weight of the vessel.

Aspect 63: The process according to aspect 61, wherein the net water loss during dehydration is from about 85% to about 95% by weight of the vessel.

Aspect 64: The process according to any one of aspect 61, wherein the vessel after dehydration has a moisture content of about 35% to about 70%.

The following non-limiting examples serve to illustrate certain embodiments of the invention but are not to be construed as limiting. Variations and additional or alternative embodiments will be readily apparent to the skilled artisan on the basis of the disclosure provided herein.

### EXAMPLES

### Example 1

To 380 grams of warm filtered water, 13.5 grams (3.43%) of agar were added and the mixture was heated with stirring. The mixture was boiled for at least about 5 minutes to activate the gelling of the agar. The mixture was cooked down to a weight of 300 grams, containing 4.5% by weight of agar. The mixture is cooled to 80-85° C. and optional ingredients, such as coloring, flavoring and sweeteners are added.

### Example 2

To prepare an edible cup, 50 grams of the hot agar mixture from example 1 was poured into a 2-part polycarbonate mold. The agar mixture was allowed to set. The outer polycarbonate mold was removed from the cup. The cup, while still on the inner mold was transferred to a dehydrator at 125° F. for dehydration. During the dehydration, 46 grams of water was removed, giving a final weight of the cup of 4 grams. After cooling, the inner mold was removed.

### Example 3

To prepare edible drinking straws, the hot agar mixture from example 1 was poured into cylindrical molds having a removeable inner plug. The agar was allowed to set. Once the agar was set, the outer mold was removed, leaving the straws on the inner plug. The straws on the inner plug were transferred to a dehydrator. Following dehydration and cooling, the straw is removed from the inner plug to provide the edible drinking straw.

### Example 4

To prepare drinking straws, mix the sodium alginate with water and glycerin using a whisk for at least 8 minutes. The resulting dough was cooled for up to 48 hours to temp near 5° C. The chilled mixture was loaded into the extruder with a hollow tube die attached to plane propulsion extruder. A lubricated mandrel was aligned to center of die and the dough was extruded around mandril at about 12″ lengths.

The mandril with extruded dough tube was placed into the cross-linking solution (10% CaCl₂ at 20-25° C.) and allowed to remain submerged with for at least 1 hour. The mandrel and straw were removed from the crosslinking solution, rinsed with room temperature water, and submerged in fresh water for at least 20 min, removed and patted dry.

The mandrel and straw were placed into a dehydrator (100° F., 3 hours). Following dehydration, the straws were allowed to cool (set) for no less than 3 hrs @ room temperature then removed from the mandrils.

### Example 5

Drinking straws were prepared by extruding alginate compositions as provided in Table 1.

TABLE 1

| Example # | Ratio (B:F:P) | Alginate | Water | Glycerin | Corn Starch | MCC | Guar | Total |
|---|---|---|---|---|---|---|---|---|
| 5A | 57.2:14.3:28.6 | 4 | 93 | 2 | | | 1 | 100 |
| 5B | 20:0:80 | 8 | 160 | 32 | | | | 200 |
| 5C | 100:0:0 | 8 | 92 | | | | | 100 |
| 5D | 63:21:15.75 | 6 | 90.5 | 2 | | | 1.5 | 100 |
| 5E | 40:40:20 | 10 | 175 | 5 | 10 | | | 200 |
| 5F | 60:10:30 | 15 | 175 | 7.5 | 2.5 | | | 200 |
| 5G | 40:40:20 | 10 | 175 | 5 | | 10 | | 200 |
| 5H | 60:10:30 | 30 | 150 | 15 | | 5 | | 200 |
| 5I | 50:0:50 | 25 | 150 | 25 | | | | 200 |
| 5J | 60:0:40 | 30 | 150 | 20 | | | | |

B: hydrocolloid (binder)
F: filler
P: plasticizer

Straws were extruded using the extrusion process of Example 4, and observations are provided in Table 2:

TABLE 2

| Example # | Pre-drying observations | Post drying observations |
|---|---|---|
| 5A | although less viscous than | good appearance at |
| | the 8% alg. baseline, still | 3 minutes |
| | extruded well, but inconsistent | |
| | in diameter | |
| 5B | Similar consistency as | very plastic like |
| | the baseline 8% alg., good | very flexible |
| | extrusion | moderate swelling in |
| | | water in water |
| | | after 10 minute in water |
| | | and it still is drinkabele |
| 5C | | rigid, plastic feel with |
| | | some flexibility |
| | | lumpy |
| | | very translucent |
| | | got some bubbles |
| 5D | | moderately opaque |
| | | matte finish |
| | | micro bubbles |
| | | flexible |
| | | high flex |
| | | medium memory |
| | | chelsea said “it feels |
| | | great” |
| 5E | Add water if too thick | very rigid |
| | in the pre-mix | strong |
| | | can be flexed |
| | | little snap |
| | | does snap when really bent |
| | | too brittle |
| | | smooth surface |
| | | matt glossy |
| 5F | Batter was runny, led | very rigid |
| | to thinner noodles. | slight bendability |
| 5G | | |
| 5H | Thicker batter, | same as 5F but more viscous |
| | easier to extrude. | when wet. |
| | | low swelling after 5 minutes |
| | | in water |

### Example 6

Drinking straws were prepared by extruding alginate compositions as provided in Table 3.

TABLE 3

| | Ratio | | | | Total |
|---|---|---|---|---|---|
| Example # | (B:F:P) | Alginate | Water | Glycerin | Mass |
| 6A | 45:0:55 | 22.5 | 150 | 27.5 | 200 |
| 6B | 45:0:55 | 22.5 | 150 | 27.5 | 250 |
| 6C | 48:0:52 | 24 | 150 | 26 | 200 |
| 6D | 48:0:52 | 24 | 150 | 26 | 250 |
| 6E | 42:0:58 | 21 | 150 | 29 | 200 |
| 6F | 42:0:58 | 21 | 150 | 29 | 250 |

B: hydrocolloid (binder)
F: filler
P: plasticizer

Straws were extruded using the extrusion process of Example 4, and observations are provided in Table 4:

TABLE 4

| Example # | observations |
|---|---|
| 6A | extrudes well |
| | matte plastic appearance |
| | good inner diameter consistency |
| | rigid but flexible |
| 6B | clear sheen-looks like plastic |
| | difficult to extrude |
| | slightly more flexible than above, but wall |
| | thickness is reduced |
| 6C | excellent extrusion |
| | excellent flexibility |
| | very good flexibility and rigidity |
| 6D | very clear |
| | elastic |
| 6E | very good plasticity |
| | very good extrusion |
| | very consistent inner diameter |
| | more flexible |
| 6F | difficult to extrude |
| | very flexible |

### Example 7

Drinking straws were prepared by extruding alginate compositions as provided in Table 6 according to the extrusion method of Example 4.

TABLE 5

| | | Alginate | Alginate | | | Extrusion |
|---|---|---|---|---|---|---|
| Example # | | 2:1 G:M | 1:1 G:M | Glycerin | water | Temp (C.) |
| 7A | Dry Mass % | 24% | 24% | 52% | | 0.2 |
| | grams | 12 | 12 | 26 | 150 | |
| 7B | Dry Mass % | 0 | 48% | 52% | | 2 |
| | grams | 0 | 24 | 26 | 150 | |
| 7C | Dry Mass % | 18% | 30.0% | 52% | | 3.2 |
| | grams | 9 | 15 | 26 | 150 | |
| 7D | Dry Mass % | 12% | 36% | 52% | | |
| | grams | 6 | 18 | 26 | 150 | |
| 7E | Dry Mass % | 6% | 42% | 52% | | |
| | grams | 3 | 21 | 26 | 150 | |
| 7F | Dry Mass % | 30.0% | 18% | 52% | | 0 |
| | grams | 15 | 9 | 26 | 150 | |
| 7G | Dry Mass % | 36% | 12% | 52% | | |
| | grams | 18 | 6 | 26 | 150 | 0 |
| 7H | Dry Mass % | 42% | 6% | 52% | | |
| | grams | 21 | 3 | 26 | 150 | 3.1 |
| 7I | Dry Mass % | 0% | 54% | 46% | | 4.4 |
| | grams | 0 | 30 | 26 | 150 | |
| 7J | Dry Mass % | 0% | 51% | 49% | | |
| | grams | 0 | 27.6 | 26 | 150 | 0 |

Straws were prepared using varying amounts of high G-block sodium alginate (2:1 G:M) and high M/G sodium alginate (1:1 G:M). Although all straws provided good properties, the straws with the greater amounts of high G-block alginate provided the best drinking straws under these conditions.

1. A low-sugar or sugar-free edible and/or biodegradable vessel, comprising about 15% to about 98% by weight of a hydrocolloid.

2. The low-sugar or sugar-free vessel according to claim 2, comprising from about 25% to about 80% by weight of the hydrocolloid.

3. The low-sugar or sugar-free vessel according to claim 2, comprising from about 45% to about 60% by weight of the hydrocolloid.

4. The low-sugar or sugar-free vessel according to any one of claims 1 to 3, wherein the vessel is a cup.

5. The low-sugar or sugar-free vessel according to any one of claims 1 to 3, wherein the vessel is a drinking straw.

6. An edible and/or biodegradable drinking straw, comprising an alginate, and optionally plasticizer.

7. The edible and/or biodegradable drinking straw according to claim 6, comprising about 20% to about 90% by weight of the alginate.

8. The edible and/or biodegradable drinking straw according to claim 6, comprising about 30% to about 65% by weight of the alginate.

9. The edible and/or biodegradable drinking straw according to any one of claims 6 to 8, wherein the alginate comprises a high G-block alginate.

10. The edible and/or biodegradable drinking straw according to any one of claims 6 to 9, wherein the alginate is crosslinked with a 2+ metal cation.

11. The edible and/or biodegradable drinking straw according to claim 10, wherein the 2+ metal cation is Ca²⁺.

12. The edible and/or biodegradable drinking straw according to any one of claims 6 to 11, further comprising a plasticizer.

13. The edible and/or biodegradable drinking straw according to claim 12, wherein the plasticizer comprises one or more of an edible oil, glycerin, a sugar alcohol such as maltitol, sorbitol or xylitol, microcrystalline cellulose, acacia gum, shellac, chitosan, genepin, nano emulsions, algae oil, coconut oils, processed shea butter, ester gums, carnuba wax, ethocell, and zein.

14. The edible and/or biodegradable drinking straw according to aspect 12, wherein the plasticizer comprises glycerin.

15. The edible and/or biodegradable drinking straw according to any one of aspects 12 to 14, wherein the plasticizer is present in the straw in an amount of from about 0% to about 70% by weight, or from about 5% to about 60% by weight.

16. The edible and/or biodegradable drinking straw according to any one of aspects 12 to 14, wherein the plasticizer is present in the straw in an amount of from about 25% to about 65% by weight.

17. The edible and/or biodegradable drinking straw according to any one of aspects 12 to 14, wherein the plasticizer is present in the straw in an amount of from about 40% to about 60% by weight.
